(19) United States
(12) Patent Application Publication
(10) Pub. No.: US 2013/0299210 A1
(43) Pub. Date: Nov. 14, 2013

(54) CABLE AND METHOD OF MANUFACTURING A CABLE

(71) Applicant: Eland Cables Ltd., London (GB)

(72) Inventor: Chris Barnes, London (GB)

(73) Assignee: Eland Cables Ltd., London (GB)

(21) Appl. No.: 13/890,729

(22) Filed: May 9, 2013

(30) Foreign Application Priority Data
May 11, 2012 (GB) 1208322.6

(51) Int. Cl. H01B 7/36; H01B 13/34

(52) U.S. Cl. CPC H01B 7/36; H01B 13/34
USPC 174/112; 156/47

(57) ABSTRACT

A cable has a marking located at least partly within the cable. A method of manufacturing the cable includes a step of providing at least one marking at least partly within the cable.

### CROSS REFERENCE TO RELATED APPLICATION

The present application claims priority under 35 U.S.C. §119 to GB Patent Application No. 1208322.6, filed on May 11, 2012, entitled “Cable and Method of Manufacturing a Cable”, the content of which is incorporated by reference herein in its entirety.

### BACKGROUND

The present invention relates to a cable and a method of manufacturing a cable.

The theft of cables, such as electrical cables, presents an increasing problem, fuelled by high demand for metal worldwide. Cables present an easy target for thieves, as it is often impractical to maintain vigilance over them, for example where the cables are located in geographically remote or covered areas, or simply because of the length of the cabling involved e.g. in a railway network.

As a result, it is not uncommon for cables to be stolen, with the metal which they contain being extracted from the cabling and sold on to third parties. Such thefts present a number of problems, which can extend well beyond the direct economic loss to the owner of the cable. For example, where the cable in question is used to supply an electrical current e.g. to a railway network or to homes, parties other than the owner e.g. railway commuters, homeowners etc. are affected and will experience inconvenience and possible knock-on economic losses of their own before the cabling is replaced and the relevant power supply system restored to normal.

It would be possible to mark the exterior of a cable to indicate ownership, in an attempt to dissuade theft, for example using commercially-available spray-on DNA-type markings sprayed onto the exterior of a cable. However, a thief need only strip the exterior sheath of a cable to readily remove the markings, and thus seek to avoid prosecution if caught with the stripped cable, as establishing ownership of the cable may then be rendered impossible.

### SUMMARY

Aspects of the invention are defined in the appended claims.

### BRIEF DESCRIPTION OF THE DRAWINGS

In order that the present invention may be more readily understood, embodiments thereof will now be described, by way of example only, with reference to the accompanying drawings, of which:

FIG. 1 shows a first embodiment of a cable according to an aspect of the present invention;

FIG. 2 is an enlarged view of a detail of the embodiment of FIG. 1;

FIGS. 3a and 3b show an identifier according to the first embodiment;

FIG. 4 is a flow chart showing a method of manufacture of a cable according to an embodiment of an aspect of the present invention;

FIG. 5 is a flow chart showing a step in the manufacture method of FIG. 4 in greater detail;

FIG. 6 shows a second embodiment of a cable according to an aspect of the present invention;

FIG. 7 is a flow chart showing a method of manufacture of a cable according to another embodiment of an aspect of the present invention; and

FIG. 8 is a flow chart showing a step in the manufacture method of FIG. 7 in greater detail.

### DETAILED DESCRIPTION

FIG. 1 shows a first embodiment of a cable 1 according to an aspect of the present invention. The cable 1 of the present embodiment is a low voltage electrical cable, intended to carry a current at a voltage of approximately 1000V, and which may for example be employed as a power or auxiliary control cable for use in applications such as in power networks, underground, outdoor and indoor applications and for use in cable ducting.

The cable 1 of the present embodiment comprises a sheath 2, armouring 3, bedding 4, insulation (shown generally at 5) and a conductor (shown generally at 6).

In the present embodiment, the sheath 2 is formed from a suitable material such as a plastics material or elastomer, for example by extrusion. In the present embodiment, the sheath 2 is formed from Polyvinyl Chloride (“PVC”) and bears an exterior marking 2A, which is described in further detail hereinafter. The sheath encloses the remaining components of the cable 2 (i.e. the armouring 3, bedding 4, insulation 5 and conductor 6 in the present embodiment) and provides mechanical and environmental protection to the cable 1, as well as holding the remaining components of the cable 1 together.

The armouring 3 is provided to protect the cable from mechanical damage as a result of external stresses being applied, either during or after installation of the cable 1. The armouring 3 of the present embodiment comprises steel wire armour (“SWA”) formed from a plurality of individual steel wires, although other suitable braids or wrappings of metal (e.g. aluminium), or suitable non-metallic material, may be used in accordance with the intended use of the cable 1.

The bedding 4 acts to protect the core of the cable from mechanical stress; in the present embodiment, the bedding 4 is formed from PVC although other materials suitable for this purpose may be employed.

The conductor 6 is provided to carry the electric current for the cable 1 and is, in the present embodiment, provided as a plurality of stranded conductors in the form of three copper wires 7, each comprising a plurality of copper strands twisted together to form the wires 7. However, any suitable type and material of conductor may be used; for example, aluminium may be used as the material for the conductor 6 of the cable 1 and the conductor 6 may be provided in forms other than a plurality of stranded conductors.

The insulation 5 of the cable 1 is provided to electrically insulate the conductor 6. In the present embodiment the insulation 5 is provided in the form of three insulating sleeves 8, each being fitted over a respective one of the wires 7. The insulating sleeves 8 may be formed of any suitable insulating material, which in the present embodiment is Cross-Linked Polyethylene (“XPLE”).

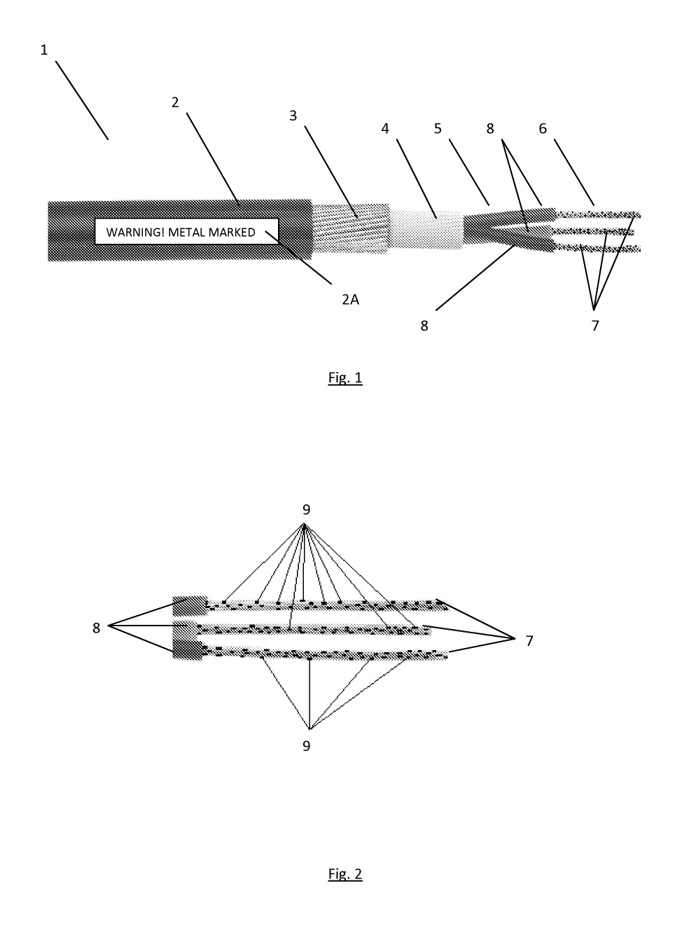

FIG. 2 is an enlarged view of a detail of FIG. 1, from which it may be seen that a plurality of identifiers 9 are present on the wires 7; in the present embodiment, these identifiers 9 are adhered to the metal conductor 6, as described in greater detail hereinafter.

Identifiers suitable for the present embodiment are manufactured by DataDot Technology Ltd. of New South Wales, Australia. It is however emphasised that the identifiers 9 of the present embodiment are merely exemplary and that other forms of identifier may be used according to the present invention. In another embodiment, for example, the identifiers can instead be provided as chemical or biological identifiers. For example, the identifiers can be made of elements which when combined in specific proportions make the compound unique.

For ease of illustration, the identifiers 9 are only shown on the exposed sections of the wires 7, but it will be understood that these identifiers 9 are present along the entire length of the wires 7 and in particular are present on the sections of the wires 7 enclosed within the sheath 2 of the cable 1.

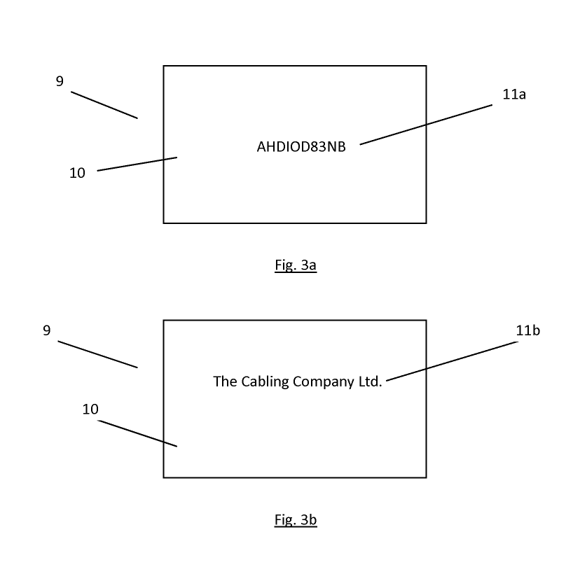

FIGS. 3a and 3b show one of these identifiers 9 in greater detail; in the present embodiment, the remaining identifiers 9 are substantially identical to that shown in FIGS. 3a and 3b and accordingly only one of these identifiers 9 will now be described.

The identifier 9 shown in FIGS. 3a and 3b takes the form of a discrete plate-like element 10, of which the front side is shown in FIG. 3a and the reverse is shown in FIG. 3b.

In the present embodiment, both the front and rear sides of the discrete plate-like element 10 bear respective indicia 11a, 11b. However, according to further embodiments, identical indicia may be provided on both the front and rear sides of the discrete plate-like elements 10, or on only a single side of the discrete plate-like elements 10, as desired.

As shown in FIG. 3a, the indicia 1 la on the front side of the discrete plate-like element 10 comprises a unique identification code in the form of a ten-character alphanumeric string. This unique identification code 11 corresponds to an entry on a secure database, and accordingly allows the cable 1 on which the identifier 9 is provided to be identified using information stored on that secure database, which may for example comprise details such as the owner and/or manufacturer of the cable 1, installation location of the cable 1 (e.g. GPS position), date of installation of the cable 1 and the like.

As shown in FIG. 3b, the indicia 11b on the reverse side of the discrete plate-like element 10 directly indicates the registered owner of the cable 1.

The discrete plate-like element 10 is preferably of a size visible to the naked eye and may for example be between 0.3 mm and 0.5 mm across. In the present embodiment, the discrete plate-like elements 10 are formed from a metallic material, such as nickel, which can withstand the manufacturing process for the cable 1 described in greater detail below.

The indicia 11a, 11b may be provided in any suitable fashion. For example, the indicia may be etched, by laser or otherwise, into the material of the discrete plate-like elements 10, may be provided as a hologram or multiple holograms on the discrete plate-like elements 10, or by any other suitable means.

In the present embodiment, each of the identifiers 9 on a given cable 1 are substantially identical and in particular bear the same indicia 11a, 11b. Thus, inspection of any one of the plurality of identifiers 9 of the cable 1 will permit the cable 1 to be identified, for example by reference to the owner, manufacturer etc., as described above. Thus, any thief wanting to be sure of avoiding detection would need to remove all of the identifiers 9 from the cable.

It will however be appreciated that any such removal is greatly hindered according to the present embodiment.

In particular, the identifiers 9 are provided within the construction of the cable 1 itself, rather than simply on the exterior of the cable. Thus, simply treating the exterior of the cable 1 in some way will not remove the identifiers 9, which are instead located within the cable 1 itself. Similarly, simply stripping the sheath 2 will not result in the identifiers 9 being removed.

Rather, it would be necessary to fully strip the cable down to its metal content i.e. the metal conductor 6 before an attempt could even be made at removing the identifiers 9.

A significant theft deterrent is thereby provided, as any thief seeking to steal the cable 1 would need to either fully strip the cable 1 down to the conductor 6, and then take action to remove the many identifiers 9, at the installation location of the cable itself, or alternatively would need to risk detection in moving the cable to another location to perform this process, but with the identifiers 9 still present. As will be appreciated, either option would render theft of the cable 1 greatly undesirable to a thief, as compared to theft of a cable having only exterior markings.

What is more, as the identifiers 9 are applied to the (valuable and hence desirable) metal content of the cable 1 itself, specifically, to the metal conductor 6 in the present embodiment, separating the identifiers from the cable 1 and its desirable metal content cannot be performed easily, and thus provides a further deterrent to theft of the cable 1.

In the present embodiment, the marking 2A on the sheath 2 draws attention to the fact that the metal content of the cable 1 is marked by identifiers 9 in accordance with the present embodiment, to deter theft of the cable 1.

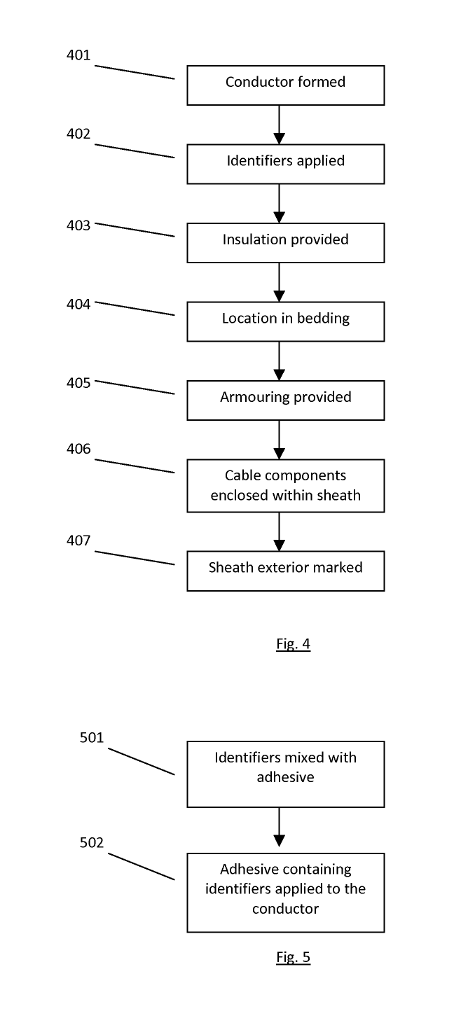

A method of manufacturing the cable 1 according to the above embodiment of the present invention will now be described with reference to FIG. 4.

In a first step 401 of the manufacturing process, the conductor 6 is formed by twisting copper strands together to form the copper wires 7.

In a second step 402, the identifiers 9 are applied to the conductor 6.

In a third step 403, the conductor 6 is provided with the insulation 5, for example by extrusion.

In a fourth step 404, the insulated conductor 6 is located within the bedding 4.

In a fifth step 405, the armouring 3 is provided around the bedding 4.

In a sixth step 406, the conductor 6, insulator 5, bedding 4 and armouring 3 are enclosed within the sheath 2.

In a seventh step 407, the sheath 2 is provided with the exterior marking 2A to communicate the presence of the theft deterrent to third parties.

It will be noted that, according to the present embodiment, the conductor 6 is marked with the identifiers 9 before the conductor 6 is enclosed within the sheath 2. As a result, the identifiers 9 are located within the sheath 2, and are not merely provided externally. This internal provision of the identifiers 9 greatly provides a significant theft deterrent, as described above.

The step 402 of applying the identifiers to the conductor 6 will now be described in further detail in conjunction with FIG. 5.

In step 501, the identifiers 9 are mixed with a carrier medium with adhesive properties.

In step 502, the carrier medium containing the identifiers 9 is applied to the metal conductor 6, which in the case of the present embodiment comprises the three wires 7, such that the identifiers 9 are adhered to the metal conductor 6.

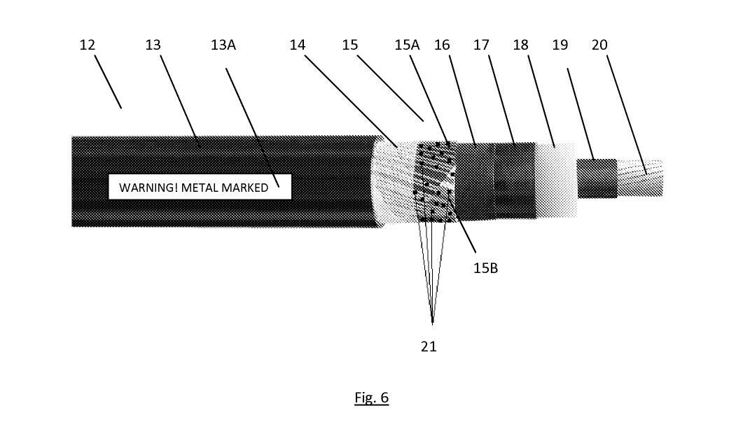

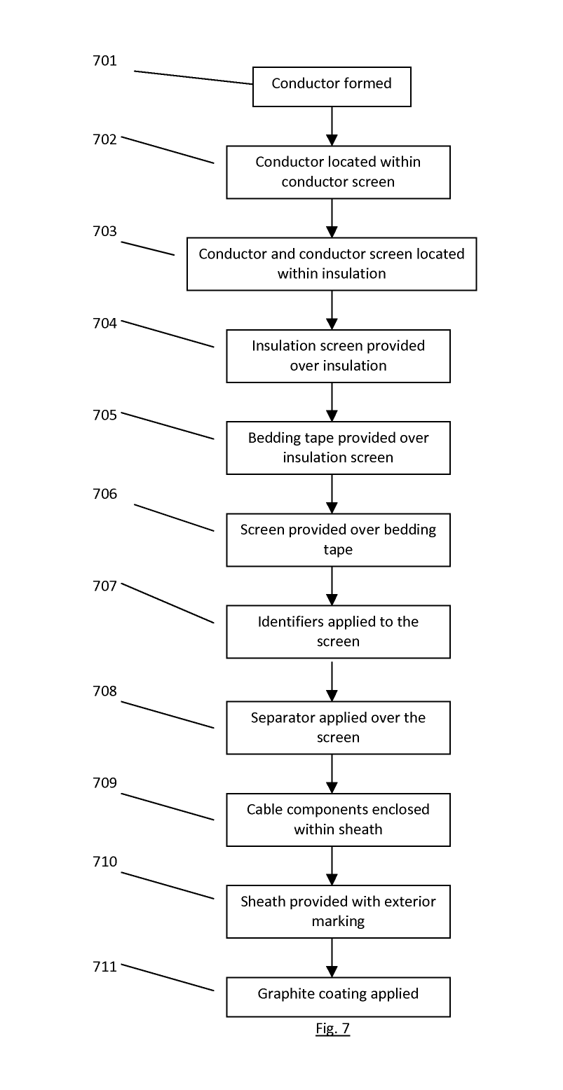

A second embodiment of a cable according to an aspect of the present invention will now be described with reference to FIG. 6.

The cable 12 of the present embodiment is a medium voltage electrical cable, rated to carry a current at a nominal voltage of approximately 33 kV, and which may for example be employed to distribute three phase alternating current electrical power supplies at nominal system voltages of 33 kV to traction substations on D.C. electrified lines.

The cable 12 of the present embodiment comprises a sheath 13, a separator 14, a screen (shown generally at 15), bedding tape 16, an insulation screen 17, insulation 18, a conductor screen 19 and a conductor 20.

In the present embodiment, the sheath 13 is formed from graphite coated Medium Density Polyethylene (MDPE) and bears an exterior marking 13A. The sheath 13 encloses the remaining components of the cable 12 (i.e. the separator 14, screen 15, bedding tape 16, insulation screen 17, insulation 18, conductor screen 19 and conductor 20 in the present embodiment) and provides mechanical and environmental protection to the cable 12, as well as holding the remaining components of the cable 12 together.

The separator 14 of the present embodiment is provided in the form of water swellable tape.

The screen 15 is a conducting layer of the cable 12 which has the function of providing an earth fault path. In the present embodiment, the screen is provided as a copper wire screen 15A helically wound with equalising copper tape 15B. A plurality of identifiers 21, which are described in greater detail hereinafter, are present along the length of the screen 15 (although, for convenience, they are only illustrated on the exposed parts of the screen 15 in the Figure). In particular, a plurality of identifiers 21 are provided along both the copper wire screen 15A and the copper tape 15, in particular on portions thereof to be enclosed within the sheath 13.

The bedding tape 16 provides a smooth transition to the underlying layer, and in the present embodiment is provided as water swellable semi-conducting tape.

The insulation screen 17 of the present embodiment is provided as solidly bonded, extruded semi-conducting Cross-Linked Polyethylene.

The insulation 18 of the present embodiment is provided as a layer of suitable electrically insulating material e.g. Cross-Linked Polyethylene.

The conductor screen 19 of the present embodiment is provided as solidly bonded, extruded semi-conducting Cross-Linked Polyethylene.

The conductor 20 of the present embodiment is provided to carry the electric current for the cable 12 and is, in the present embodiment, provided as a compact circular stranded plain copper conductor. However, any suitable type and material of conductor may be used; for example, a circular solid aluminium conductor maybe be used as the conductor 20.

Except that the indicia 11a, 11b of the identifiers 21 will relate to the cable 12 of the present embodiment, the identifiers 21 are of exactly the same form as the identifiers 9 of the first embodiment, and accordingly the identifiers 21 are not described further here. Similarly, the sheath 13 of the present embodiment is marked at 13A in the same way as the sheath 2 of the first embodiment is marked at 2A, to communicate the theft deterrent of the cables to third parties, in particular by referring to the presence of the indicators 21 contained within the construction of the cable 12.

As will be appreciated, the present embodiment thus enjoys similar theft-deterrent benefits as the first embodiment. In particular, in the present embodiment, each of the identifiers 21 located within the cable 12 are substantially identical and in particular bear the same indicia 11a, 11b. Thus, inspection of any one of the plurality of identifiers 21 of the cable 12 will permit the cable 12 to be identified, for example by reference to the owner, manufacturer etc., as described above. Thus, any thief wanting to be sure of avoiding detection would need to remove all of the many identifiers 21 from the cable 12.

It will however be appreciated that any such removal is greatly hindered according to the present embodiment.

In particular, the identifiers 21 are provided within the construction of the cable 12 itself, rather than simply on the exterior of the cable 12. Thus, simply treating the exterior of the cable 12 in some way will not remove the identifiers 21, which are instead located within the cable 12 itself. Similarly, simply stripping the sheath 13 will not result in the identifiers 21 being removed.

Rather, it would be necessary to strip the cable 12 down to access the metal content presented by the screen 15 before an attempt could even be made at removing the identifiers 21.

A significant theft deterrent is thereby provided, as any thief seeking to steal the cable 12 would need to expend significant time in stripping the cable 12 to access the screen 15, and then take action to remove the many identifiers 21, at the installation location of the cable itself before removing the metal content presented by the screen 15, or alternatively would need to risk detection in moving the cable 12 to another location to perform this process, but with the identifiers 21 still present. As will be appreciated, either option would render theft of the cable 12 greatly undesirable to a thief, as compared to theft of a cable having only exterior markings.

What is more, as the identifiers 21 are applied to (valuable and hence desirable) metal content of the cable 12 itself, specifically the metal presented by the copper screen 15, separating the identifiers 21 from the cable 12 and this desirable metal content of the cable 12 cannot be performed easily (it would be almost impossible for the thieves to ensure that all of the indicia have been removed) and thus provides a further deterrent to theft of the cable 12.

In the present embodiment, identifiers 21 are not provided on the metal conductor 20. This is primarily for safety considerations, as in the present embodiment the identifiers 21 comprise plate-like elements 10 and are preferably metallic, e.g. of nickel, as described above in conjunction with the first embodiment. As the cable 12 of the present embodiment is intended to carry current at a higher voltage than the cable 1 of the first embodiment, the identifiers 21 are not provided on the metal conductor 20 as if any of the plate-like elements 10 comprising the identifiers 21 were to be affixed to the metal conductor 20 standing proud from the surface of the conductor 20, damage to the remainder of the cable 12 could occur given the magnitude of voltage carried, possibly causing the cable 12 to fail.

However, if a different type of identifier 21 were used, which did not present such safety concerns, it is conceivable that the identifiers 21 could also be applied to the conductor 20, in addition to the screen 15.

Further, it will be appreciated that the present invention is widely applicable to allow any desired component, e.g. any component formed from or containing metal, metal alloy or any other valuable material, of a cable to be provided with indicia e.g. by means of identifiers such as the identifiers 9, 21.

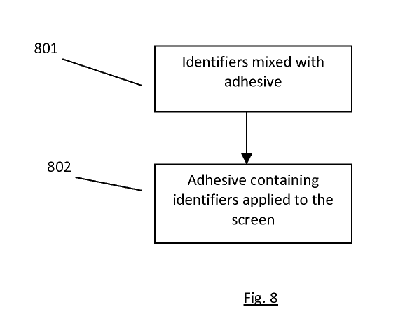

A method of manufacturing the cable 12 according to the above-described second embodiment of the present invention will now be described with reference to FIG. 7.

In a first step 701 of the manufacturing process, the conductor 20 is formed by twisting copper strands together to form the copper wire.

In a second step 702, the conductor 20 is located within the conductor screen 19.

In a third step 703, the conductor 20 and conductor screen 19 are located within the insulation 18.

In a fourth step 704, the insulation screen 17 is provided over the insulation 18.

In a fifth step 705, the bedding tape 16 is provided over the insulation screen 17.

In a sixth step 706, the screen 15 is provided over the bedding tape 16.

In a seventh step 707, the identifiers 21 are applied to the metal screen 15.

In an eighth step 708, the separator 14 is applied over the screen 15.

In a ninth step 709, the conductor 20, conductor screen 19, insulation 18, insulation screen 17, bedding tape 16, screen 15 and separator 14 are enclosed within the sheath 13.

In a tenth step 710, the sheath 13 is provided with the exterior marking 13A to communicate the presence of the theft deterrent to third parties.

In an eleventh step 711, a graphite coating is applied to the sheath 13.

It will be noted that, according to the present embodiment, the metal screen 15 is marked with the identifiers 21 before the metal screen 15 is enclosed within the sheath 13. As a result, the identifiers 21 are located within the sheath 13, and are not merely provided externally of the cable. This internal provision of the identifiers 21 provides a significant theft deterrent, as described above.

The step 707 of applying the identifiers 21 to the screen 15 will now be described in further detail in conjunction with FIG. 8.

In step 801, the identifiers 21 are mixed with a carrier medium with adhesive properties.

In step 802, the carrier medium containing the identifiers 21 is applied to the metal screen 15, which in the case of the present embodiment comprises the copper wire screen 15A and copper tape 15B, such that the identifiers 21 are adhered to the metal screen 15.

According to embodiments, the present invention may be applied to many other types of cable, for example to signalling cable, telecommunications cable and the like, as well as power cables.

It will be understood that embodiments of the present invention are described herein by way of example only, and that various changes and modifications may be made without departing from the scope of the invention. In particular it is emphasised that the types of cable of the first and second embodiments described above have been selected for exemplary illustration purposes only, and that the present invention is by no means limited to the specific types of cable described above.

1. A cable within which at least one marking is at least partly located.

2. A cable according to claim 1, wherein the cable comprises a sheath within which at least one further component of the cable is at least partly located, and wherein the at least one marking is at least partly located within the cable by being at least partly located within the sheath.

3. A cable according to claim 2, wherein the at least one marking is applied to the at least one further component of the cable.

4. A cable according to claim 3, wherein the at least one marking is applied to the at least one further component of the cable by adhesion.

5. A cable according to claim 1, wherein the at least one marking comprises a plurality of discrete elements each bearing or constituting the same indicia.

6. A cable according to claim 1, wherein the at least one marking is unique to the cable.

7. A cable according to claim 1, wherein said at least one marking comprises an indication relating to at least one of the ownership of the cable, the manufacturer of the cable, an installation location of the cable and a date of installation of the cable.

8. A cable according to claim 1, wherein said at least one marking comprises an alphanumeric indicia.

9. A cable according to claim 2, wherein said at least one further component of the cable comprises metal or metal alloy.

10. A cable according to claim 1, wherein the cable is an electrical cable arranged to carry an electrical current.

11. A cable according to claim 9, wherein the cable is an electrical cable arranged to carry an electrical current and the metal or metal alloy comprises the electrical conductor of the electrical cable.

12. A cable according to claim 9, wherein the cable is an electrical cable arranged to carry an electrical current and the metal or metal alloy comprises an electrical screen of the electrical cable.

13. A cable according to claim 1, wherein the cable further comprises a further marking applied to the exterior of the cable indicating the presence of the at least one marking located at least partly within the cable.

14. A method of manufacturing a cable, the method comprising the step of providing at least one marking at least partly within the cable.

15. A method according to claim 14, wherein the cable further comprises a sheath with at least one further component of the cable at least partly located within the sheath, and wherein said step of providing at least one marking at least partly within the cable comprises providing the at least one marking at least partly within the sheath.

16. A method according to claim 15, wherein said step of providing the at least one marking at least partly within the sheath is performed before the at least one further component of the cable is at least partly located within the sheath.

17. A method according to claim 15, wherein said step of providing at least one marking comprises applying said at least one marking to the at least one further component of the cable.

18. A method according to claim 17, wherein said applying said at least one marking comprises applying said at least one marking to the at least one further component of the cable by adhesion.

19. A method according to claim 14, wherein the at least one marking comprises a plurality of discrete elements each bearing or constituting the same indicia.

20. A method according to claim 14, wherein the at least one marking is unique to the cable.

21. A method according to claim 14, wherein said at least one marking comprises an indication relating to at least one of the ownership of the cable, the manufacturer of the cable, an installation location of the cable and a date of installation of the cable.

22. A method according to claim 14, wherein said at least one marking comprises an alphanumeric indicia.

23. A method according to claim 15, wherein said at least one further component of the cable comprises metal or metal alloy.

24. A method according to claim 14, wherein the cable is an electrical cable arranged to carry an electrical current.

25. A method according to claim 23, wherein the cable is an electrical cable arranged to carry an electrical current and the metal or metal alloy comprises the electrical conductor of the electrical cable.

26. A method according to claim 23, wherein the cable is an electrical cable arranged to carry an electrical current and the metal or metal alloy comprises an electrical screen of the electrical cable.

27. A method according to claim 14, wherein the method further comprises applying a further marking to the exterior of the cable indicating the presence of the at least one marking located at least partly within the cable.
